(19) United States
(12) Patent Application Publication
(10) Pub. No.: US 2013/0124272 A1
(43) Pub. Date: May 16, 2013

(54) METHOD AND SERVER SYSTEM FOR ENHANCED MANAGEMENT OF EVENT-BASED USER REWARDS

(71) Applicants: Marja Hohti, Helsinki (FI); Ramine Darabiha, Helsinki (FI); Harri Koponen, Kauniainen (FI)

(72) Inventors: Marja Hohti, Helsinki (FI); Ramine Darabiha, Helsinki (FI); Harri Koponen, Kauniainen (FI)

(73) Assignee: ROVIO ENTERTAINMENT LTD., Espoo (FI)

(21) Appl. No.: 13/294,500

(22) Filed: Nov. 11, 2011

(30) Foreign Application Priority Data
Nov. 11, 2011 (FI) 20116121

(51) Int. Cl. G06Q 30/02

(52) U.S. Cl. 705/14.3

(57) ABSTRACT

Provision of enhanced rewarding schemes. A first server of a first service domain is configured to maintain a reward database for users of a first service domain. A second server of a second service domain is configured to identify event data items of the second service domain from which information is to be forwarded to the first service domain, and derive information from the identified event data items to forwarded data items. The first server is configured to update the reward account of the user in response to event data items generated in response to activities of the user in the first service domain, and in response to forwarded data items received from the second server.

### FIELD OF THE INVENTION

The present invention relates to information systems and specifically to an enhanced arrangement for managing event based user rewards.

### BACKGROUND ART

Business today means much more than merely simple production and delivery of manufactured goods. Products and services generated around branded concepts form whole, independently managed ecosystems.

Many ecosystems maintain some kind of loyalty programs where users are rewarded for selected type of activities performed in these ecosystems. For example, airline companies have traditionally offered frequent flyer programs where airline customers enrolled in the program accumulate frequent flyer miles according to the distance flown on that airline or its partners. Acquired miles can be redeemed in the ecosystem for free air travel, goods and services, travel class upgrades, priority bookings etc.

There are also many types of arrangements for integrated co-operation between ecosystems. For example, many frequent flyer programs allow points to be obtained not only by flying, but by favoring partnering ecosystems on the ground. Points can be collected by, for example, staying at hotels of a partnering hotel chain, renting a car from a partnering rent-a-car company, or shopping at a particular chain of department stores. There are also arrangements for debit and credit cards that offer frequent flyer points for charges made to the card. Other similar examples are available in other fields of business. The problem with these arrangements is that they require laborious and rigid partnering arrangements and strict information synchronization regimes between the participating systems.

Co-operated rewarding schemes are, however, definitely needed. Typically each of the service domain provides its users with a special, branded card that carries some identification method (a magnetic stripe, a chip, a printed character set etc.) in or on it. The more active a user is, the more cards he will get and finally one ends up carrying a pack of cards with him. Users find this very irritating and easily refuse from joining some of the offered rewarding schemes.

An alternative approach to co-operation is provided by electronic coupons, the value of which may cumulatively increase according to purchases made from participating partner companies. The electronic coupon can also be redeemed in any of the partnering ecosystem. Also these arrangements, however, require rigid partnering arrangements and extensive sharing of information between the parties.

In general, a great obstacle for development of co-operating rewarding schemes is that user information and statistics on their behavior is typically one of the most valuable assets of a company and details of them are not traditionally shared with other companies. However, in order to implement the referred conventional programs, a high level of trust needs to be established between the partnering companies before any arrangements can be established. In addition, changes and modifications to an established arrangement typically require acceptance from all participating parties, or at least from the parties whose operations are affected by the change. Clearly more dynamic solutions would, however, be preferred.

### SUMMARY

An object of the present invention is to provide an arrangement by means of which one or more of the problems of the co-operated rewarding schemes may be avoided or alleviated. The object of the invention is achieved by a method, a system, an apparatus, a computer program product and use, which are characterized by what is stated in the independent claims. The preferred embodiments of the invention are disclosed in the dependent claims.

The invention is based on a specifically configured division of required tasks and functions between the co-operating parties. This division facilitates more extensive and dynamic utilization of user activities in offered and implemented user rewarding schemes. Advantages of the invention are discussed in more detail with respective embodiments of the invention.

### BRIEF DESCRIPTION OF THE DRAWINGS

In the following, embodiments will be described in greater detail with reference to accompanying drawings, in which

FIG. 1 illustrates an embodiment of a system according to the present invention;

FIG. 2 illustrates a simple embodiment for a forwarding scheme;

FIG. 3 illustrates exemplary configurations for forwarded information items;

FIG. 4 illustrates the basic mode of operation of a rewarding scheme;

FIG. 5 illustrates another embodiment of a system according to the present invention;

FIG. 6 illustrates an embodiment of a method implemented in a server system of a rewarding service domain; and

FIG. 7 illustrates an embodiment of a method implemented in the server system of a forwarding service domain;

FIG. 8 shows a block diagram illustrating an embodiment of an apparatus.

### DETAILED DESCRIPTION OF SOME EMBODIMENTS

In the following description, for the purposes of clear explanation, a number of specific details are set forth in order to provide a thorough understanding of the embodiments of the invention. It is apparent to one skilled in the art that embodiments of the invention may, however, be practised without one or more of these specific details or with some equivalent arrangement. In other instances, well-known structures and units may be shown in block diagram form in order to avoid obscuring the embodiments of the invention.

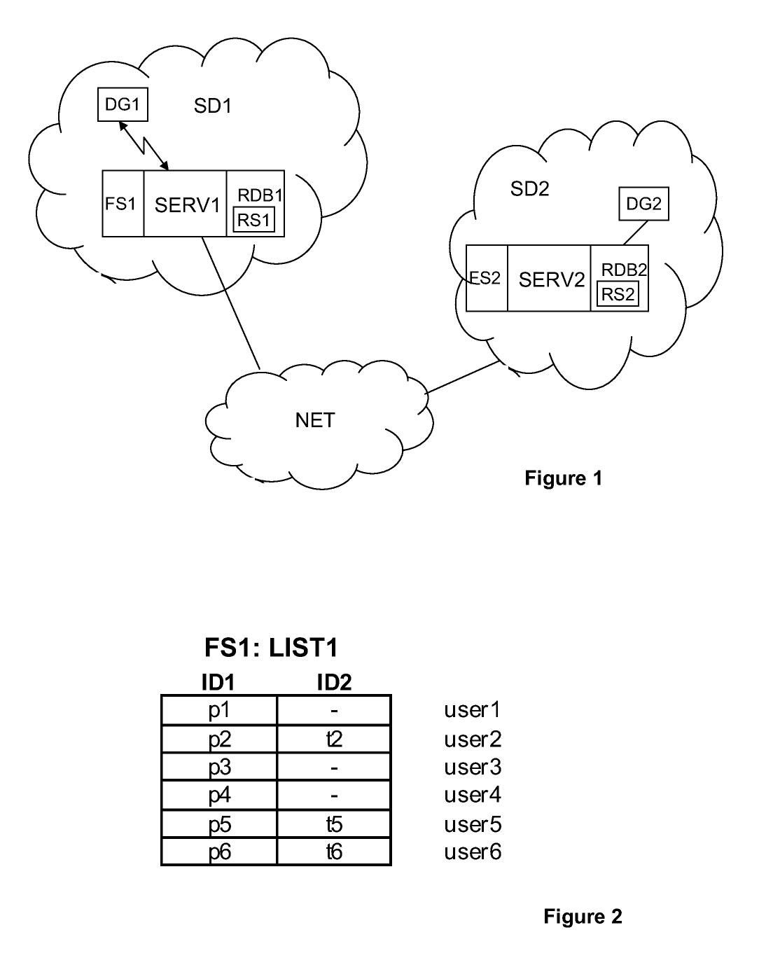

FIG. 1 is a diagram illustrating an embodiment of a system according to the present invention. The system comprises two service domains, a first service domain SD1 and a second service domain SD2. The term service refers here to at least one unit of commodity that is made available to at least one user, and the availability of which is administered according to a common set of rules. A unit of commodity may be a physical object or an activity, performed for a user in real world or in a virtual environment. The term service domain thus refers to a group of commercial entities that control the common set of rules according to which one or more units of commodity forming a particular service is made available to users. A user may acquire a subscription to the service domain and thereby receive a user identity to which the common set of rules apply, and by means of which services provided in the service domain are made accessible to him or her.

The first service domain SD1 and the second service domain SD2 are different service domains. This means that user identities and the common set of rules applied in a service domain are managed independently of any other service domain. The service domains SD1 and SD2 are, however connected through a network NET such that information may be exchanged between the service domains.

Elements SERV1 and SERV2 illustrate server systems in the respective service domains. A server system represents here a logical entity formed by one or more interconnected physical server elements that implement operations according to the common set of rules of the service domain it serves. A server system thus provides access to a specific set of files and functions controlled by the service provider. A simple server system may be implemented by means of one physical computer entity that comprises a network interface, a database, and a processor system that is configured to implement a defined service logic that manages operations in the server. The network interface facilitates reception of operational information from terminal units and other service domains. The database stores user-specific information and a set of functions required for provision of the offered services. The service logic may be implemented as a set of coded rules according to which functions are invoked in the processor system in response to the received operational information. The server system is, however, typically implemented as an interconnected set of physical server elements that synchronize their information according to a predefined scheme, and which are managed by the service provider(s) of the service domain.

Elements DG1 and DG2 illustrate terminal units that act as data generators in their respective service domains. In order to simplify the description, two different types of data generators are shown and discussed in more detail with FIG. 1. It is noted, however, that the invention is applicable by a person skilled in the art to any two independently managed service domains, notwithstanding the type of terminal unit and data generators applied in the service domain. For example, DG1 and DG2 may represent also similar data generators operated in different service domains.

A data generator refers here to a network entity that is connected to the server system and thus able to exchange information with it. As a simple example, let us assume that the first service domain SD1 is related to a software application, more specifically to a game made available to users by the service provider of the first service domain. A user may subscribe to the game and acquires thereby a player identity that is unique in the mobile game environment and is controlled independently by the game service provider. In this context, the first DG1 data generator is a gaming device, an apparatus capable of accessing the first server SERV1 via one or more wired or wireless networks, or a combination of them. Advantageously the gaming device is a mobile device that allows the user to access services of SERV1 uninterruptedly while moving around in various positions.

Continuing the example, let us assume that the second service domain SD2 is related to a logistic application, more specifically to a travel card system. In defined points of service, the travel card system comprises a payment terminal DG2. The payment terminal DG2 represents a point of sale where a user is recognized by the user identity applied in the second service domain, and a user activity in the second service domain is recorded. In the present embodiment, the payment terminal may comprise a near field communication (NFC) reader and the user may have a NFC enabled object that can be bought to the vicinity of the reader. The NFC enabled object may be any object that is provided with functions of a NFC tag, including a RFID card, a card with an integrated or externally applied NFC tag, or an NFC-enabled mobile phone. The NFC enabled object is hereinafter referred to as a payment module. Accordingly, the user may pay for travel in a specific route by tapping his payment module to the reader.

The user may, along with his other daily routines, use services of one or more service domains. For example, he may play a game released by the service provider that manages the first service domain. The game may be an online game, during which the player continuously exchanges information with a game server. During gaming, event data items in the first service domain are created. An event data item of a service domain refers to a block of data that comprises an identity indication, which allows identification of the user in the particular service domain, and an activity indication, which identifies an activity performed by or for the user in the service domain. In the exemplary gaming context, an event data item may comprise the player identity of the user and details of a specific achievement recorded for the user, or of an action performed by the user. The game server SERV1 may monitor gaming information it exchanges with the gaming device DG1 of the player, and create from at least part of the gaming information event data items of the second service domain.

The game may also be a single player, independently played game that does not repeatedly communicate with a game server. However, also these types of games may be configured to send, at selected situations, information on how the game proceeds. Such situation could be, for example, when a game is started, when it is ended, when a particular level is achieved, etc. Again, the game server SERV2 may monitor the messages it receives from the gaming device DG1 of the player, and create from at least part of them event data items of the second service domain.

On the other hand, the user may also travel and use a payment module OBJ to pay for his trip. In this exemplary context, an event data item may comprise a traveler identity of the user and details of the trip paid with the payment module. The payment module and the NFC reader DG2 may be configured to deliver from the payment module to the NFC reader a second user identity that identifies the user in the travel card system. The NFC reader DG2 may create an event data item that comprises the traveler identity as an identity indication and details of the trip as event indication. Alternatively, the NFC reader DG2 may be configured to merely send out all information it gathers to a travel card system server SERV2 and the event data item is created in the server.

Use of the services of the two service domains is in no way inherently linked. The user may play the game notwithstanding whether he travels in the vehicles provided by the service provider of the travel card system. And vice versa, he may play the game at any time without travelling in a vehicle. Actually, he may even use the services of the two separate service domains simultaneously, i.e. play the game while sitting in a train. Provision of the services and creation of the event data items takes place independently in either of the service domains, and they are fully in control of the parties providing the services.

In embodiments of the invention, at least one of the service domains maintains a reward system for its users. In order to show the advantages of the invented solution, an embodiment where both service domains maintain separate rewarding schemes is disclosed. So, continuing the example, let us assume that the gaming server SERV1 of the first service domain SD1 comprises, is connected to, or has network access to a reward database RDB1. A reward database of a service domain comprises a plurality of reward accounts, each related to a user identity applied in the service domain. Accordingly, in the gaming context, each player identity is associated with a player account and part of this player account may carry information on rewards granted to the player. The rewards recorded and stored in one reward database are rewards accessible to the user in that particular service domain. Accordingly, the reward accounts maintained in the reward database RDB1 of the first service domain may comprise services or products that are released and/or made available by services of the first service domain. In the gaming application context such services could contain, for example, in-application game awards, like additional game characters, new accessible levels, virtual credit for in-application purchases, etc. If the gaming application is complemented with side products, like branded toys, videos, comic strips, music, etc. reward services could be implemented as discounts given when purchasing these items.

In many service domains, when a user subscribes to services of a service domain, he is allocated a unique subscriber identity, and a reward account is opened for that user identity. Typically, rewards are given based on events and transactions performed in the subscribed service domain only. Joint rewarding systems of two or more independently managed service providers conventionally require laborious arrangements to verify that the party releasing the reward is truly expected and/or authorized to release the reward in his own service domain, to convey to the party granting the reward information that the reward has been claimed, and to ensure that compensations between the service domains are duly recorded and made. Most commonly, various physical or electronic coupon systems have been applied for the purpose. The problem is that users are nowadays expected to carry a number of different customer loyalty cards and coupons and are getting more and more reluctant to get involved with complicated mutual rewarding schemes. A more userfriendly approach to joint rewarding schemes is clearly needed.

A traditional way to approach joint operations in general is to add integration between the co-operating parties. For rewarding schemes this conventional approach is, however, not easily applicable. Customer and subscriber information is typically considered as an essential part of assets of a company and service providers are very reluctant to share this type of information with any other party. Both the identities of the users as well as transactions they perform are not willingly shared with other operators, and many times sharing is not even possible without explicit confidentiality agreements made with the users. The present invention discloses an arrangement that allows provision of joint rewarding schemes in such a way that involved parties can efficiently control and manage use of their confidential customer information and independently design and update their own rewarding schemes. For this, in the present invention, a reward account of a user is updated in response to event data items generated in response to user activities in the first service domain, and in response to transaction data items associated to the user and received from a second service domain.

Continuing the example again, let us assume that the travel card system server SERV2 of the second service domain SD2 comprises, is connected to, or has network access to a reward database RDB2 of its own. Each of the reward databases RDB1, RDB2 includes a rewarding scheme RS1, RS2, correspondingly. A rewarding scheme carries one or more rules or rulesets to implement a particular business logic that maps service events to reward account transactions. In the gaming environment a rewarding scheme RS1 could, for example, comprise a rule that defines release of a specific game character when a defined number of defined game events have been detected in the event data items of the first service domain. In travel card environment, a rewarding scheme RS2 could, for example, comprise a rule that grants a free trip when a defined amount of payments have been made in the second service domain.

In order to allow co-operated rewarding arrangements between the service domains SD1, SD2, the service domains maintain a forwarding scheme FS1, FS2. A forwarding scheme of a service domain comprises one or more rules or rulesets, based on which event data items that are relevant for another rewarding scheme are detected. Information derived from these event data items is then to be forwarded to the service domain where that rewarding scheme is applied.

FIG. 2 illustrates a simple embodiment for a forwarding scheme FS1 in the first server system SERV1 of FIG. 1. As discussed above, the first server system SRV1 may be a gaming server in which a list LIST1 of player identities ID1 (p1, p2, p3, p4, p5, p6) allocated to users at the time they subscribe to the first service domain is maintained. For co-operated rewarding, this first user identity ID1 is associated in the list with a second user identity ID2, i.e. a subscriber identity of the same user in the second service domain. For example, the player may provide his second user identity in the travel card system to be recorded to the first service domain at the time of registering to the first service, or update it to his user record at a later time when he wishes to utilize the co-operated rewarding arrangements. Alternatively, the same user may provide his first user identity in the second service domain SD2, and the second service domain may forward to the first service domain information that associates the first user identity and the second user identity.

The information associating a first and a second user identity may be delivered from the second service domain to the first service domain continuously as individual pieces of information or in batches. For example, the payment module may be configured to carry two NFC tags, each providing a separate user identity. In the example of FIG. 1, a travel card may be configured to inherently provide the second user identity applied in the travel card system. When a user becomes a player in the game, he may simply receive a sticker that operates as a NFC tag that may be read in a NFC reader and thereby provides the player identity allocated to the user. The arrangements may be naturally varied in many ways. For example, a more advanced method is to incorporate identification mechanisms applied in both service domains into one card. The card may be issued when necessary authorizations for exchange of event data items have been acquired from the user.

In the simple case, the travel card reader DG2 may be configured to read both NFC tags and deliver this information to SRV2 that passes the information forward to SRV1. On the other hand, the user may provide his player ID to the travel card system and the travel card system may provide information indicating this association to the game service domain. The simple example of a forwarding scheme FS1 is thus a rule that defines that whenever an event data item is received in SRV1, player identity ID1 is extracted from the event data item, and the LIST1 is searched to see whether a second user identity corresponding to the first user identity exists. The rules may define further that if a second user identity is detected in the LIST1, the event data item, or information derived from that event data item is forwarded to the second service domain SD2. In the simplified example of FIG. 2, users u2, u5 and u5 have subscribed to both services domains and the user identities ID1, ID2 are associated in the LIST1. If SERV2 detects that an event data item carries a player identity p2, information on or from the event data item is forwarded to SD2. If the extracted player identity is p3, information on the event remains in the first service domain only.

A corresponding example can be given for the forwarding scheme FS2 of the second service domain. As above, a user of a travel card may provide his player ID1 and authorize exchange of information to the travel card system at the time he registers into to system. Alternatively, the card reader DG2 may be configured to allow users to input their player ID1 into the system at a later time. For example, the card reader DG2 may be configured to first identify the user by reading normally his second user identity ID2, and then read an additional NFC tag, which provides the first user identity ID1 after. The server system SERV2 of the travel card application may be configured to store a corresponding list as shown in FIG. 2, and forward information on its own events whenever a first user identity for a detected second user identity is available in the list. The server system may also operate dynamically, such that information on events in the second service domain are forwarded to the first service domain only when the two user identities ID1, ID2 of the user are provided to the system at the time of making the payment.

It should be noted that the given methods and technologies are examples only. Various methods for providing and recording user identities and implement mapping between user identities applied in different service domain are widely known to a person skilled in the art, and may be used without deviating from the scope of protection.

Event data items may be created specifically for the purpose of facilitating co-operating rewarding schemes. Alternatively, general event logs recorded during normal operation of the service domain may be used as event data items, as long as a record of the log comprises identification indication of the user and activity indication that identifies the activity performed by the user. If event data items are tailored for the joint rewarding operations, they may be created directly so that only information necessary for implementing the joint operations is included in the event data item. In such a case, event data items may be forwarded as such from one service domain to another. If this is not the case, it is likely that the event data items comprise information that the second service domain does not need and/or the operator of the first service domain does not want to deliver to the second service domain. In such a case, information received in event data items may be first processed and only information derived from the event data item forwarded to the other service domain. The minimum requirement for the forwarded information is that it includes an identification indication by means of which a user whose activity triggered generation of the event data item in the forwarding service domain is included, and an activity indication that represents the activity performed by the user. Other type of information may be included, as well. For example, the time when the transaction was performed, and/or the location of the point of sale where the transaction was performed may be included in the forwarded information. The amount of information included in a forwarded data item may be selected to match with the level of confidentiality maintained between the different service domains.

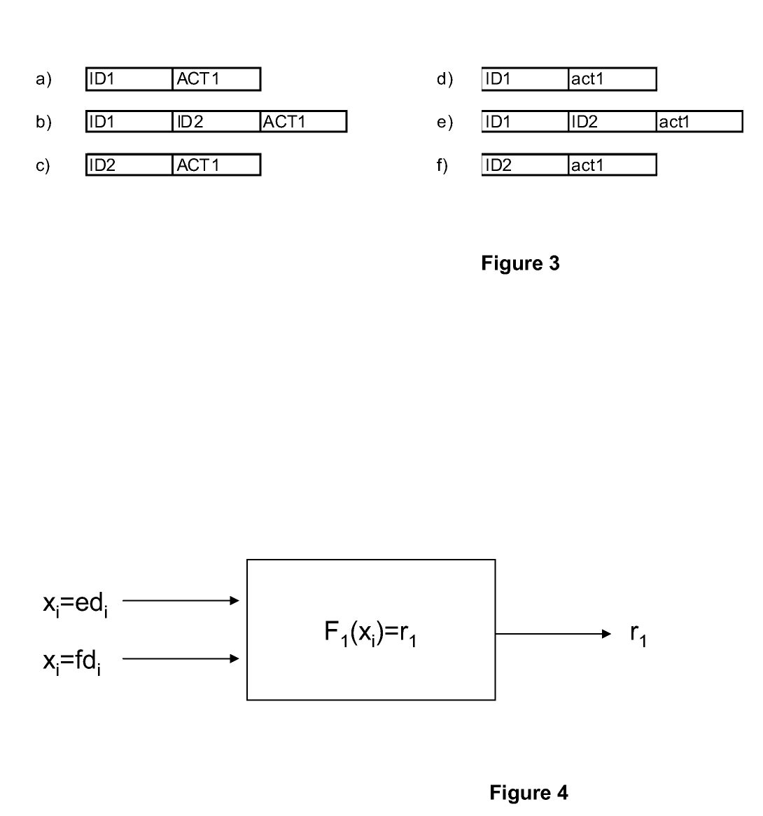

FIG. 3 illustrates some exemplary configurations for forwarded information items. The activity indication ACT1 in items a) to c) represents a piece of information that is extracted from an event data item and included as such to the forwarded data item. Such arrangement is appropriate when the forwarding service domain generates event data items from non-confidential events, or when a user has authorized the forwarding party to use event information for other purposes, for example to forward the information to another service domain. The activity indication act1 in items d) to f) is, on the other hand, generated by again extracting a piece of information that indicates the performed activity in the event data item and a specific algorithm is used to translate the extracted piece of information to an activity indication act1. The translation refers here to any modification, encryption or relation mechanism by means of which a piece of information is transformed into a form that is different from the original form but conveys at least part of the original informative content of the piece of information. The activity indication act1 preferably represents reward eligibility of the activity performed by the user in the forwarding service domain but does not disclose the performed activity as such.

For example, in the exemplary embodiment of FIG. 1, game events are typically not considered as confidential information, and typically players are therefore quite willing to authorize use of such game events also for other purposes, especially for rewarding purposes. Therefore activity indications of items a) to c) could be well used in the first service domain SD1 of FIG. 1. On the other hand, information that allows other parties to trace where a person has been or travelled to is typically considered confidential information and it is not very likely that people would easily authorize service providers to use their travel information for other purposes, not even for potential rewards. Therefore SERV2 could be configured with a translation algorithm that reads an event data item generated by the payment terminal DG2 and extracts from it a piece of information that indicates details of the travelled trip. A predefined algorithm processes the piece of information and generates a modified activity indication that only represents rewarding eligibility of the trip, not details of the trip itself. Rewarding eligibility could be indicated by means of, for example, points corresponding to the length of the trip.

In items a) and d), identification indication includes the first user identity ID1 of the user applied in the forwarding service domain, here the first domain SD1. This structure may be applied if a good level of confidentiality exists between the forwarding and rewarding parties. It also requires that the receiving party maintains its own list that allows mapping between the first user identity ID1 and the second user identity ID2 of the user. In items b) and e), identification indication includes both the first user identity ID1 of the user in the forwarding service domain and the second user identity ID2 of the same user in the forwarding service domain. This structure may be applied if, again, a good level of confidentiality exists between the parties and also the required information for mapping the user identities is more easily available in the forwarding service domain. This may be the case if, for example, the rewarding party does not maintain the list that allows mapping between the first user identity ID1 and the second user identity ID2 of the user. The combination of user identities ID1, ID2 is also useful when the forwarded data item is used at the same time as an announcement that an authorization for associating the user identities for rewarding parties has been requested or authorized by the user in the forwarding service domain.

In items c) and f), identification indication includes the second user identity ID2 only. This structure allows the service provider of the forwarding party an additional level of privacy. The structure is also well applicable in arrangements where only the receiving service domain rewards its users. For example, let us assume that in the exemplary case of FIG. 1, only the game service provider maintains reward accounts, but is willing to grant rewards also based on travel card activities. The travel card system may wish to participate to the campaign, but does not wish to reveal its user identities or trip details to the game service domain. The campaign may be implemented simply by configuring the travel card system to detect event data items that carry the first user identity (e.g. read from the game application sticker on the payment module) and the second user identity (e.g. read from the payment module itself). If such an event data item is detected, the user identity applied in the forwarding service domain, here the first user identity ID1 is removed from the event data item. In addition, a translation algorithm may be used to modify the information detailing the trip into a modified activity indication act1 that does not disclose the trip itself, only rewarding eligibility of the trip. The remaining user identity ID2, the player identity applied in the game service domain SD1 and the modified activity indication act1 may be combined into a data item as shown in item d) and forwarded from SD2 to SD1.

A forwarding scheme is a dynamic tool by means of which the co-operating parties can combine two independently operating ecosystems for rewarding purposes. The forwarding scheme is included as a functional element into the service domain of one party to contribute to rewarding operations of another party. Forwarding mechanisms may be easily adjusted to match with confidentiality of the information processed in each of the ecosystems, and/or the level of confidentiality existing between the parties. As a rulesetbased automatic function, the forwarding scheme may be modified as often as necessary and is therefore consistently up to date. The forwarding scheme may be updated in response to a control messages transmitted from the service domain to which information is forwarded, or in response to a user activity performed in the forwarding service domain. The forwarding service domain may allow updates to the forwarding scheme automatically, or it may be configured to update the forwarding scheme only after the update has been authorized by a main user of the forwarding service domain. A main user may refer here to one or more nominated persons provided with necessary credentials to enable a defined group of requested operations. For example, if the forwarding scheme is configured to forward information on all event data items relating to users in a separately maintained list, adding new members to the list may be allowed automatically. On the other hand, if the forwarding scheme is a generic rule, modifications to that rule may be configured to require authorization by a named operator in the forwarding service domain.

The rewarding scheme RS1, RS2 is, on the other hand, a functional element that is located in the service domain of a party that implements the rewarding operation, and remains fully in control of the rewarding party, even if two or more parties may contribute to it. FIG. 4 illustrates the basic mode of operation of a rewarding scheme, here the first rewarding scheme RS1 of the first service domain SD1 of FIG. 1. The rewarding scheme provides a function F that may comprise one or more rules, rulesets, tables, and/or algorithms that are invoked according to a defined, preferably programmed scheme. The function F inputs a data item xᵢ related to a user and according to its predefined scheme computes an reward account update operation rᵢ to be performed to the reward account of that user. The data item xᵢ may be an event data item edᵢ generated in the service domain SD1 of the rewarding scheme RS1 or a forwarded data item fdᵢ received from another service domain SD2. The defined scheme F may be dynamically modified. The rewarding scheme may thus be dynamically adjusted and new, even daily campaigns can be very easily implemented.

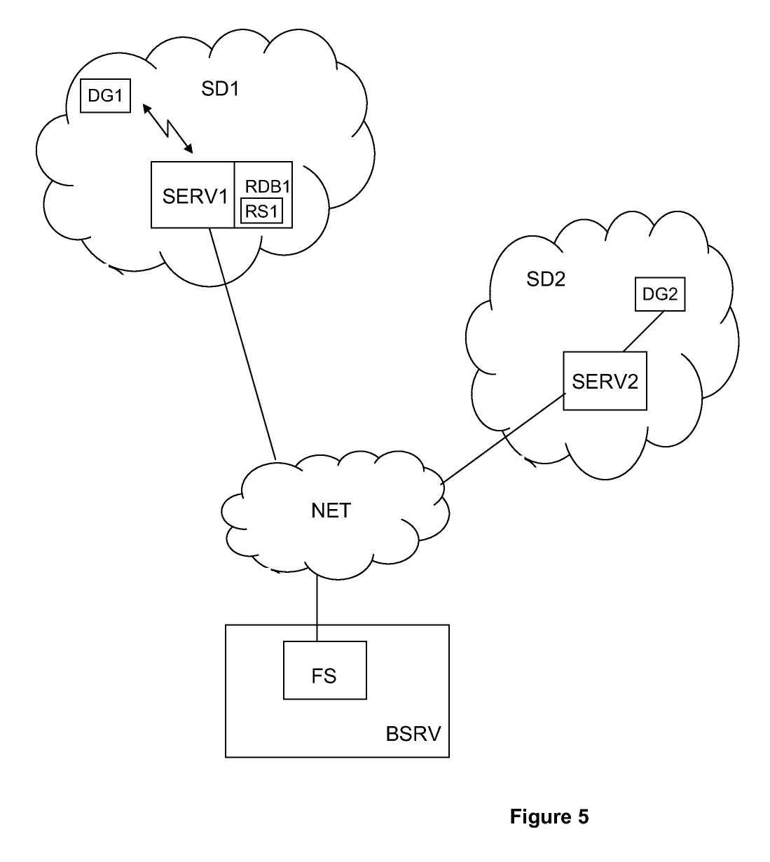

FIG. 5 illustrates another embodiment of a system according to the present invention. Elements already discussed in FIG. 1 are denoted with same characters, so more detailed description on them may be referred from description of FIG. 1. In the configuration of FIG. 5, forwarded data items are not delivered directly from one service domain to another, but a trusted party that is inherently involved in transactions of the second service domain is included in the arrangement. An example of such trusted party is a bank that maintains a bank account for the user. For conciseness of the description, let us assume that this time the co-operation works only in one way, i.e. only the provider of the gaming application in SD1 is interested to reward its players also from activities in the other service domain SD2. As shown in FIG. 5, a forwarding scheme FS is now maintained in the server system BSRV of the trusted party. The payment module is basically any object that facilitates provision of details of the bank account of the user and necessary credentials to complete a payment transaction in the second service domain SD2. In the example of FIG. 5, the payment module is a bank card with an integrated magnetic strip of electronic chip that carries the required user and bank account information. Any other valid payment method, like an electronic wallet maintained in a mobile user device may be applied without deviating from the scope of protection.

As earlier, the forwarding scheme FS is based on availability of an element that facilitates mapping between a subscriber identity applied in the service domain that applies the rewarding scheme (rewarding party) and a subscriber identity used by the entity that records user activity in the other service domain (forwarding party). The element may be located and maintained in the server system of the forwarding party or of the rewarding party. For example, in the present let us assume that the user wishes to travel from place to another and pays his trip in the payment terminal DG2 with his bank card. The user is a registered player in the gaming ecosystem and therefore has a user identity applied therein.

The required mapping may be implemented simultaneously with a transaction. In one possible implementation, the payment terminal may be configured to receive additional user information and associate it to the trans-action information generated upon the payment. For example, in a simple case, a user may join the co-operated rewarding schemes by accepting exchange of event information. His user identities in the service domains are thereby integrated in at least one instance in the server systems of the involved parties. In one example, the user may acquire an additional identification method, for example a NFC tag that carries his player identity and is glued on or integrated into his bank card. The user may provide his player identity by tapping the NFC tag to a NFC reader connected to the payment terminal and the payment terminal may be configured to add the player identity to a generated transaction record and the information on the transaction, as well as the identity information is delivered to the bank. In this case, the bank may process the payment normally, and the forwarding scheme FS may provide rules that configure the server system of the bank to forward transaction records, part of transaction records or information derived from transaction records that comprise the added player identity to the first service domain SD1 of the gaming application ecosystem. The server system SRV1 of the first service domain may be provided with limited or limitless access to modify the forwarding scheme FS, or have no access to the FS at all. If the trusted party is a bank, access to FS is naturally very strictly controlled.

Alternatively, the required mapping may be implemented by the trusted party without involving the user and the server system of the second service domain to the procedure. When a user registers to the first service domain SD1, he may be asked to provide his bank account number and authorization to use this bank account number for collecting transaction information from other service domains. If such authorization is gained, a database mapping the user identity of the user in the rewarding service domain ID1 and the bank account number of the user may be maintained in the first service domain and/or by the trusted party.

If the database is maintained in the first service domain SD1, the first service domain SD1 may provide the bank with a list of account numbers that have authorized use of their transaction records, and the forwarding scheme FS may provide rules that configure the server system of the bank to forward transaction records, part of transaction records or information derived from transaction records of the listed bank accounts to the first service domain SD1 of the gaming application ecosystem. The server system of SD1 and the server system of the bank are advantageously configured to synchronize the list at defined intervals. The forwarding scheme FS may thus operate on the basis of the bank account number only, and the identification identity included in forwarded data items may comprise the bank account number of the user. The forwarded data items may be preprocessed by mapping the included bank account number into a player identity before submitting the forwarded data item to the rewarding scheme RS1.

If the database is maintained in the server system of the trusted party, i.e. here the bank, the first service domain SD1 may provide the bank with a list of player identities of its registered players and the bank will extract transactions related to the bank account number associated with those player identities and forward information on them to the first service domain.

The proposed arrangement provides a solution, by means of which transactions of the user in two or more service ecosystems may be holistically applied in an independently and dynamically managed rewarding scheme of one service ecosystem. The proposed configuration facilitates provision of new and innovative rewarding schemes and co-operated business models that may be applied in an optimal way for the benefit of all involved parties.

It is noted that even if the mechanisms has been described in the context of two separate service providers, it is clear to person skilled in the art that the arrangement is applicable to co-operated rewarding schemes between two or more service domains. In addition, a described service domain may represent a cluster of service providers operating according to shared rulesets and rewarding databases.

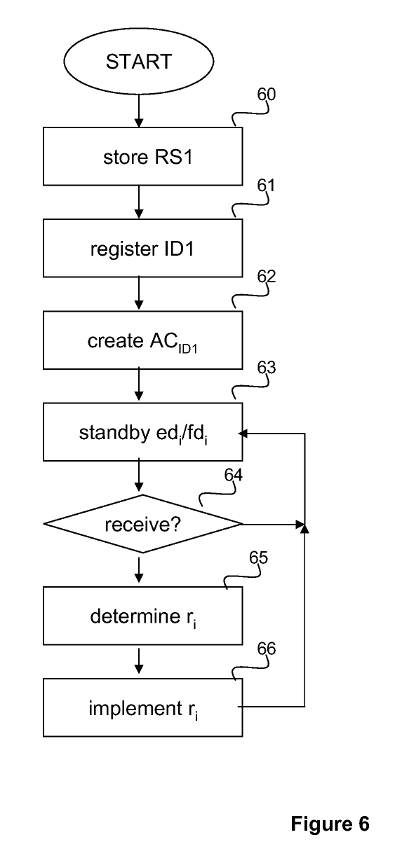

FIG. 6 illustrates an embodiment of a method implemented in the server system SERV1 of the first service domain SD1 in FIGS. 1 and 5. Additional description for the terms and concepts may thus be referred from description of these figures. The method shows a procedure implemented for one user, application of the same procedure for a plurality of users is obvious for a person skilled in the art. The procedure begins in a stage where the server system is normally initialized and in operative state. The database of the server system is initially configured with a rewarding scheme RS1 (stage 60) that provides rewarding logic F by means of which selected user activities are translated into rewards granted for the user. When a user registers to the first service domain SD1, a unique user identity ID1 is allocated to him (stage 61). Also a reward account AC_{ID1} is created (stage 62) for the user. After this, the server system is ready to receive data items (stage 63), event data items edᵢ from the first server or forwarded data items fdᵢ received from a second service domain SD2 or from a trusted party TP of the second service domain. When a data item is received (stage 64), the server system applies the stored rewarding scheme RS1 to determine an update operation rᵢ (stage 65) to be performed in the reward account of the user and implements (stage 66) the determined update operation.

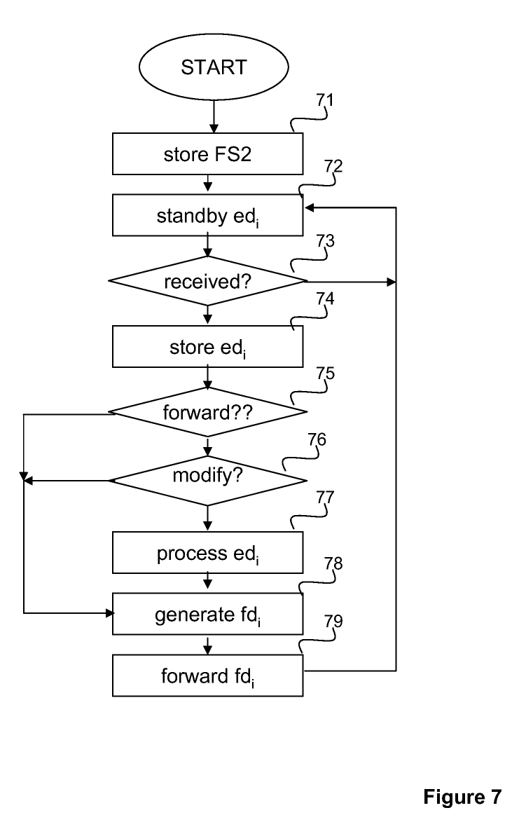

FIG. 7 illustrates an embodiment of a method implemented in the server system SERV2 of the second service domain SD2 in FIG. 1. Additional description for the terms and concepts may thus be referred from description of FIG. 1. The procedure begins in a stage where the server system is normally initialized and in operative state. The server system SD2 is first configured with a forwarding scheme FS2, which provides rules and algorithms that enable the server system SERV2 of the second service domain SD2 to detect event data items that comprise information, which is valid for the rewarding system maintained in the first service domain SD1. When this is done, the server system SERV2 begins to monitor the flow of recorded event data items (stage 72). When an event data item is detected (stage 73), the server system SERV2 records it normally (stage 74) but also uses the forwarding scheme FS to check (stage 75) whether information on the event should be forwarded to the first service domain or not. If the check is positive, the server system may also check in which form the information should be forwarded. Especially, the server system SERV2 may check (stage 76) whether information on the nature or content of the event can be forwarded as such to the first service domain, or whether some modification to the activity and/or identification indication should be made for confidentiality reasons. If such modification is required the server system may use a translation algorithm to derive information to be included in a forwarded data item (stage 77). A forwarded data item is generated (stage 78) from the event data item, a piece of information extracted from the event data item, or event information derived from the event data item. The forwarded data item is then transmitted (stage 79) to the first service domain.

As disclosed earlier, a server system may be implemented as a device or as a networked combination of devices. In general, various embodiments of such device or devices may be implemented in hardware or special purpose circuits, software, logic or any combination thereof. Some aspects may be implemented in hardware, while some other aspects may be implemented in firmware or software, which may be executed by a controller, microprocessor or other computing device. Software routines, which are also called as program products, are articles of manufacture and can be stored in any device-readable data storage medium and they include program instructions to perform particular tasks. The exemplary embodiments of this invention also provide a computer program product, readable by a computer and encoding instructions for executing the methods described above.

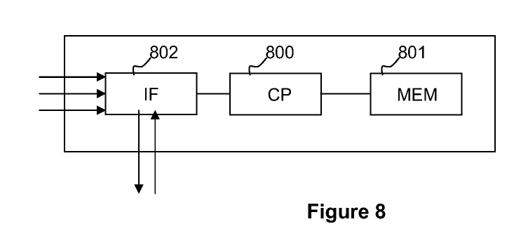

Embodiments of this invention relate also to a device, which is applicable as a server system in the above embodiments, and provides means for implementing the above described methods. FIG. 8 shows a block diagram illustrating configuration of an exemplary device for the purpose.

The device comprises a processor unit 800 for performing systematic execution of operations upon data. The processor unit 800 is an element that essentially comprises one or more arithmetic logic units, a number of special registers and control circuits. Memory unit 801 provides a data medium where computer-readable data or programs, or user data can be stored. The memory unit is connected to the processor unit 800. The memory unit 801 typically comprises volatile or non-volatile memory, for example EEPROM, ROM, PROM, RAM, DRAM, SRAM, firmware, programmable logic, etc.

The device also comprises an interface unit 802 with at least one input unit for inputting data to the internal processes of the device and at least one output unit for outputting data from the internal processes of the device. The interface unit 802 of the device may also comprise a user interface with a keypad, a touch screen, a microphone, and equals for inputting user data and a screen, a touch screen, a loudspeaker, and equals for outputting user data.

The processor unit 800, the memory unit 801, and the interface unit 802 are electrically interconnected to provide means for systematic execution of operations on received and/or stored data according to predefined, essentially programmed processes of the device. These operations comprise the procedures and functions described for the device in FIGS. 1 to 7.

While various aspects of the invention may be illustrated and described as block diagrams, message flow diagrams, flow charts and logic flow diagrams, or using some other pictorial representation, it is well understood that the illustrated units, blocks, device, system elements, procedures and methods may be implemented in, for example, hardware, software, firmware, special purpose circuits or logic, a computing device or some combination thereof.

It is apparent to a person skilled in the art that as technology advances, the basic idea of the invention can be implemented in various ways. The invention and its embodiments are therefore not restricted to the above examples, but they may vary within the scope of the claims.

1. A method, comprising
maintaining a reward database for users of a first service domain, a user of the first service domain having a unique first user identity independently managed in the first service domain, and a record of the reward database relating a first identity of the user to a personal reward account;
updating the reward account of the user in response to event data items generated in response to activities of the user in the first service domain, and in response to forwarded data items generated in response to activities of the user in a second service domain.

2. A method according to claim 1, comprising
identifying event data items of the second service domain from which information is to be forwarded to the first service domain;
deriving information from the identified event data items to the forwarded data items.

3. A method according to claim 2, comprising
maintaining a first ruleset comprising rules for identifying event data items of the second service domain from which information is to be forwarded to the first service domain.

4. A method according to claim 3 comprising updating the first ruleset in response to a control message received from the first service domain.

5. A method according to claim 4, comprising
transmitting the control message from the first service domain to a main user controlling use of the first ruleset;
updating the first ruleset in response to the control message after an authorization by the main user.

6. A method according to claim 2, comprising including in a forwarded data item an identification indication identifying a user whose activity triggered generation of the event data item in the second service domain, and an activity indication representing the activity performed in the second service domain.

7. A method according to claim 6, wherein the identification indication comprises a first user identity of the user, or a second user identity of the user, or the first and the second user identity of the user.

8. A method according to claim 6, comprising
extracting a piece of information indicating the performed activity from the event data item;
including the extracted piece of information to the activity indication.

9. A method according to claim 6, comprising
extracting a piece of information indicating the performed activity from the event data item;
translating the piece of information to an activity indication that represents reward eligibility of the performed activity but does not disclose the performed activity.

10. A method according to claim 3, comprising maintaining the first ruleset in the server system of the second service domain.

11. A method according to claim 3, comprising maintaining the first ruleset in the server system of a trusted party involved in transactions of the second service domain.

12. A method according to claim 2, comprising providing information for identifying the event data items at the time of performing the user activity in the second service domain.

13. A method according to claim 1, wherein the reward database comprises a modifiable function for determining an update operation to the reward account of the user based on an input event data item or a forwarded data item.

14.-43. (canceled)

44. A system comprising:
a first server of a first service domain; and
a second server of a second service domain,
wherein the first server is configured to maintain a reward database for users of a first service domain, a user of the first service domain having a unique first user identity independently managed in the first service domain, and a record of the reward database relating a first identity of the user to a personal reward account;
wherein the second server is configured to identify event data items of the second service domain from which information is to be forwarded to the first service domain, and derive information from the identified event data items to forwarded data items;
wherein the first device is configured to update the reward account of the user in response to event data items generated in response to activities of the user in the first service domain, and in response to forwarded data items received from the second server.

45. A computer program embodied on a computer readable medium, said computer readable medium comprising:
code for maintaining a reward database for users of a service domain, a user of the service domain having a unique user identity independently managed in the service domain, and a record of the reward database relating the user identity to a personal reward account;
code for receiving event data items generated in response to activities of the user in the service domain;
code for receiving from an other service domain forwarded data items generated in response to activities of the user in the other service domain;
code for updating the reward account of the user in response to event data items generated in the first service domain, and in response to the forwarded data items.

46. A computer program embodied on a computer readable medium, said computer readable medium comprising:
code for receiving event data items generated in response to activities of the user in a service domain;
code for maintaining a ruleset comprising rules for identifying event data items of the service domain from which information is to be forwarded to an other service domain.
